(19) United States
(12) Patent Application Publication
(10) Pub. No.: US 2026/0055800 A1
(43) Pub. Date: Feb. 26, 2026

(54) BEARING ARRANGEMENT COMPRISING A ROTATION-TRANSLATION CONVERTER, IN PARTICULAR FOR A BRAKE DEVICE, AND LINEAR ACTUATING DEVICE

(71) Applicant: Schaeffler Technologies AG & Co. KG, Herzogenaurach (DE)

(72) Inventors: Wolfgang Fugel, Nürnberg (DE); Peter Lehnhoff, Nürnberg (DE); Andreas Krome, Oberreichenbach (DE); Mario Kreutzer, Sonneberg (DE); Jürgen Engel, Adelsdorf (DE); Florian Schmidt, Dietersheim (DE)

(73) Assignee: Schaeffler Technologies AG & Co. KG, Herzogenaurach (DE)

(21) Appl. No.: 19/104,244

(22) PCT Filed: Aug. 11, 2023
(86) PCT No.: PCT/DE2023/100590

§ 371 Date: Feb. 17, 2025

(30) Foreign Application Priority Data
Aug. 18, 2022 (DE) 10 2022 120 854.0

(51) Int. Cl. F16H 25/24; F16C 19/10; F16D 55/226; F16D 65/18; F16D 65/22; F16D 121/24; F16D 125/40

(52) U.S. Cl. CPC F16H 25/24; F16C 19/10; F16D 65/18; F16D 65/22; F16D 55/226; F16D 2121/24; F16D 2125/40

(57) ABSTRACT

A bearing arrangement includes a rotation-translation converter, a support component and an axial bearing with a single cage. The rotation-translation converter includes a first component that is axially positionally fixed and rotatable, and a second component that is axially movable by rotation of the first component. The axial bearing is for supporting the first component on the support component. The single cage includes a plurality of first pockets populated by first needles and having a first root circle diameter, and a plurality of second pockets, separate from the first pockets, populated by second needles and having a second root circle diameter that is greater than the first root circle diameter.

### CROSS-REFERENCE TO RELATED APPLICATIONS

This application is the U.S. National Phase of PCT Appln. No. PCT/DE2023/100590 filed Aug. 11, 2023, which claims priority to German Application No. DE102022120854.0 filed Aug. 18, 2022, the entire disclosures of which are incorporated by reference herein.

### TECHNICAL FIELD

The present disclosure relates to a bearing arrangement, having a rotation-translation converter that includes an axially positionally fixed, rotating first component and a second component that is axially movable by rotation of the first component; a support component; and an axial bearing via which the rotating first component is supported on the support component.

### BACKGROUND

Such a bearing arrangement is used wherever a controlled linear actuation movement is to be generated with the help of the rotation-translation converter driven by an actuator. For example, such a bearing arrangement can be used in a braking device of a motor vehicle, e.g., an electromechanical parking brake or an electromechanical service brake such as a caliper or drum brake. A bearing arrangement includes a rotation-translation converter, consisting of an axially positionally fixed but rotatable first component and a linearly movable, rotationally-secured second component which is coupled to the first component and can be axially moved by the rotation of the first component. The element to be positioned is directly or indirectly coupled to the second component, for example a brake pad in the case of a braking device.

The rotating first component is driven by an electromechanical actuator, usually an electric motor, possibly via a transmission interposed therebetween. Depending on the direction of rotation of the first component, the second component can be moved axially in both directions, so that a reversing actuation operation is possible. The rotation-translation converter can, for example, be a ball screw drive consisting of a threaded spindle, a threaded nut and balls accommodated therebetween. The threaded spindle can be rotated via the actuator and represent the first component, while the threaded nut moves along the threaded spindle and represents the second component. Alternatively, the threaded nut can be actively rotated and form the first component, while the threaded spindle is moved axially through the threaded nut. In any case, axial support of the rotating but axially positionally fixed component by means of an axial bearing on a surrounding structure, i.e., a support component, is required in order to support the axial forces acting during actuation operation or to direct them into the surrounding structure.

From DE 10 2015 201 487 A1, an axial bearing is known, in which needles are provided as rolling elements, whereby the bearing consists of two separate, concentrically arranged cages.

### SUMMARY

The present disclosure provides that the axial bearing is a needle bearing that has only one cage. The cage has a plurality of first pockets which are populated with needles and have a first root circle diameter, and a plurality of second pockets which are separate from the first pockets, that are populated with needles and have a second root circle diameter. The second root circle diameter is greater than the first root circle diameter.

The bearing arrangement according to the disclosure has a multitude of advantages over previously known designs, which are particularly suitable for the described application in a purely electromechanical vehicle brake or a combined vehicle brake with a hydraulically actuated service brake and an electromechanically actuatable parking brake device (a so-called parking brake). On the one hand, shorter rolling elements are used, which leads to a reduction in friction. On the other hand, the load rating can be increased and also varied as a result of the two-row needle arrangement in the individual needle roller and cage assemblies, which are located on different pitch circles and each have a multitude of individual needles offset in the circumferential direction.

The use of only a one-piece cage is advantageous for both production and assembly, as it also enables a more stable design of the cage or bearing. This also means simpler production and lower material requirements. The use of a one-piece cage also results in advantages in terms of installation space with regard to the radial bearing width, as the individual needle roller and cage assemblies can be positioned radially as best and as closely as possible to each other. Compared to an axial ball bearing, a shorter axial width is also achieved by using the corresponding needles. Furthermore, it is possible to use not only needles of the same length, but needles of different lengths, e.g., shorter first needles in the radially inner needle roller and cage assembly and longer second needles in the radially outer needle roller and cage assembly.

In the case of different deformations of the environment or of the components to be supported against each other under load, it is generally possible to use not only identical needles, but also different types of needles for each needle roller and cage assembly. This is advantageous because it enables uniform pressure to be applied to the different rows of needles when there are changes in the geometry of the components being supported, which lead to dishing when the cage is subjected to a correspondingly high load, which is beneficial for the service life of the axial bearing.

The bearing arrangement according to the disclosure has an axial bearing with only one annular cage, which, however, is provided with first and second pockets with respective needles located on different pitch circles. Consequently, there are two separate pocket roller and cage assemblies or needle roller and cage assemblies, each of which has a plurality of pockets or needles offset in the circumferential direction, but located on different pitch circles.

The first pockets, which are further inside when viewed radially, have a first root circle diameter, which defines the radially inner end of the pocket. The second pockets, which are further outside, are located on a second root circle diameter that is greater than the first root circle diameter, which means that this pocket roller and cage assembly is positioned further out when viewed radially. Only one needle is arranged in each pocket. The outer needle roller and cage assembly can have more pockets and therefore hold more needles than the inner needle roller and cage assembly. It is therefore possible to accommodate more load-bearing rolling elements in the same installation space than with single-row needle roller and cage assemblies, which increases the load-bearing capacity or reduces the contact pressure for the same load, resulting in a longer service life, lower friction and better efficiency.

The one-piece cage also makes it possible to make the cage narrower and more compact when viewed radially in comparison to an axial bearing consisting of two separate, concentrically arranged cages. This is because the two individual cages must be provided with corresponding edge rims with a specific geometry that engage behind each other in the installed position. Such rim geometries as in a double-row needle bearing are not required in the axial bearing used according to the disclosure. A web remains between the inner pocket roller and cage assembly and the outer pocket roller and cage assembly, which web can be kept very narrow.

In comparison with an axial bearing consisting of two cages, the axial bearing according to the disclosure can be designed to be shorter when viewed radially than the axial bearing having the two separate cages, with a comparable load-bearing capacity. Compared to an axial bearing with two cages, with the same radial length, it is possible to make the pockets and thus also the needles longer, which in turn leads to an increase in the load rating. However, since the pockets and consequently also the needles are shorter compared to a single-row axial bearing, the friction in the bearing according to the disclosure is also lower.

The shorter pockets also increase the stability of the cage in the pocket area because, unlike a single-row cage, there is hardly any twisting under load that could affect the needle guidance into the pockets. In a single-row axial bearing, long needles are used to achieve the required load-bearing capacity. For this reason, the pockets must also be of a corresponding length. Compared to such a single-row axial bearing, the pocket and needle dimensions of the axial bearing used according to the disclosure are smaller, and a circumferential web remains between the pocket roller and cage assemblies, which stabilizes the cage and the pockets.

Manufacturing is also simpler because a one-piece cage is used, on which all pockets can be formed in a common punching or forming step. Compared to manufacturing an axial bearing with two separate cages, less punched waste is generated during punching. The handling and installation of the one-piece cage is also much easier compared to that of a bearing with two separate cages, which must be secured against falling apart during installation of the axial bearing or must be installed separately.

Since the one cage provided according to the disclosure has the two needle roller and cage assemblies, each of which forms a bearing plane, both bearing planes can therefore be mounted in a common installation process. This installation process is simple because the needles are snapped into the pockets anyway and are therefore secured against loss, and the cage equipped with the needles is easy to handle as a complete structural unit and can be brought into the installation position.

According to a further development, the second root circle diameter may be greater than a first crown circle diameter of the first pockets. The design results in a pocket pattern in which the inner first pockets are formed in an inner annular zone which, when viewed radially, is slightly spaced apart from an outer annular zone, in which the second pockets are arranged. This means that the first and second pockets are separated from each other in this design, both in the circumferential direction and in the radial direction.

This design makes it possible to vary the number of pockets in the respective pocket roller and cage assemblies over a wide range and also to increase it to a maximum, whereby the number of outer second pockets is usually greater than the number of first pockets. The second pockets can be arranged in radial extension of the first pockets as well as partially overlapping or in gaps between the first pockets, which means that the respective local arrangement of the pockets can be chosen as desired.

In principle, however, it is also conceivable that the second root circle diameter is smaller than the crown circle diameter. In this variant, the first and second pockets overlap, as seen in the circumferential direction. In this design, the second pockets are arranged in sections between two first pockets and extend radially outwards.

Depending on the selected local arrangement of the pockets or the selected root and crown circle diameters, the number of first pockets can correspond to the first number of second pockets or be smaller than the number of second pockets. The same number of pockets is given, for example, when the second pockets are arranged, when viewed radially, in extension of the first pockets or when they are arranged in gaps between the first pockets, or when, as described above, there is an overlap in the circumferential direction and they are unavoidably arranged in gaps. If the root circle diameter of the second pockets is greater than the crown circle diameter of the first pockets, a greater first number of pockets is given, for example, if the second pockets are arranged both in extension and in gaps between the first pockets. There is therefore a large range of possible variations, which can influence in particular the load-bearing capacity of the axial bearing, but also the friction.

According to a further development, it can be provided that the first and the second pockets, seen in the radial direction, have the same length. Accordingly, the pockets are geometrically identical, i.e., they are, when viewed radially, the same length and the same width in the circumferential direction. Consequently, identical needle-shaped rolling elements can be inserted into both the first and the second pockets. This is advantageous from a manufacturing point of view.

Alternatively, it is also possible for the first and second pockets, seen in the radial direction, to have different lengths, but may have the same width. Here, needles with two different lengths but the same diameter are used, which in turn can influence the load-bearing capacity and friction.

To further stabilize the cage, a cylindrical annular rim is expediently provided on the inner circumference and/or the outer circumference of the cage, which is formed during the punching or forming process and by means of which the cage is reinforced against torsion.

Furthermore, the axial bearing can also include one or two axial discs on which the rolling elements roll. In principle, the axial bearing can only have the cage and the needles and as such can be positioned in direct contact with the components to be supported if suitable running surfaces for the rolling elements are provided on the components. Since this is often not the case, the axial bearing according to the disclosure has one or two axial discs, which on the one hand have the corresponding running surfaces for the rolling elements, and on the other hand are supported on the respective component in the installation position. However, it is also conceivable that the axial bearing is only formed by the cage equipped with the needles, i.e., no additional axial disc is installed with the cage and the needles run directly on surfaces of the components that are to be supported axially against each other.

The axial discs can be simple annular discs that are positioned as separate bearing discs. However, it is also conceivable to design the or each axial disc as an angled disc, which has a cylindrical disc flange which is snapped onto an annular rim of the cage. In this design, one or both angled discs are connected to the cage to form a workable bearing unit, which further simplifies assembly.

The bearing arrangement is particularly suitable for use in a reversing linear actuating device, e.g., a braking device such as an electromechanical or a combined electromechanical/hydraulic disc or drum brake, where a brake pad is moved relative to and away from a braking element to be decelerated via the bearing arrangement in conjunction with an actuator. In this case, the reversing rotation-translation converter only converts one rotation of less than 360° during a stroke to move the brake pad into contact with the braking element, i.e., the brake disc or the brake drum, or out of contact with the braking element. This means that the axial bearing only has to allow a few revolutions of 360° or only a pivot movement of usually less than 360° per braking stroke.

In the virtually load-free state, i.e., the starting position, the cage and all rolling elements can align with each other. However, due to the small pivot angle, slip and deformation conditions occurring during the working stroke are so small that they can be easily accommodated or absorbed by the usual pocket play of the rolling elements in the pockets or generate only very small forces on the cage. After the return stroke to the virtually load-free initial state has been completed, the needles and the cage can realign with each other and any forces can be reduced.

In addition to the bearing arrangement itself, the disclosure also relates to a linear actuating device, including an actuating element to be moved linearly, an electromotive actuator, and a bearing arrangement according to the above disclosure. The actuator is coupled to the first component of the rotation-translation converter, while the second component of the rotation-translation converter is coupled to the actuating element to be moved. The linear actuating device includes a bearing arrangement according to the disclosure including the rotation-translation converter and the axial bearing provided there according to the disclosure.

The rotating first component of the converter, e.g. the threaded spindle of the converter designed as a ball screw drive, is supported and mounted on a fixed support component. This support component can be any surrounding component, e.g. a wall of a housing that accommodates the converter or the housing of the coupled actuator. The actuator itself may be an electric motor, which is optionally coupled to the rotating first component of the converter via a transmission, so that a rotational movement is introduced into the converter via the actuator. There, the rotational movement is converted into a translational movement of the linearly movable second component and, for example, the threaded sleeve is moved axially. This component is in turn coupled to the element to be positioned linearly, which is then moved accordingly. Since the rotation-translation converter works reversibly, this actuation movement can take place in both directions. The forces and deformations that occur are optimally supported or absorbed by the axial bearing integrated in the bearing arrangement according to the disclosure.

The linear actuating device may be a braking device including at least two brake pads, at least one of which is the actuating element to be moved and is to be moved by means of the actuator against a braking element to be decelerated. The braking device can be a disc brake or a drum brake. A disc brake includes a brake caliper having at least two brake pads, and at least one brake pad is connected as the element to be adjusted to the linearly movable second component of the rotation-translation converter. The actuator applies an axial force to the brake pad, which is pressed linearly against a brake disc.

Sometimes the brake caliper, is mounted in a floating manner so that the brake disc is pressed and decelerated between the linearly moving brake pad and a brake pad provided on the opposite side. A reversing movement of the converter relieves the brake pad again and cancels the braking application. A drum brake has a brake drum and usually two quasi semi-circular brake pads accommodated in the brake drum, which are pivotably mounted at one end. A common brake cylinder is provided between the other ends of both brake pads, which has the bearing arrangement, or two such brake cylinders are provided for one brake pad each in a duplex arrangement. The brake pads are pressed apart by the rotation-translation converter for braking and pressed against the brake drum in frictional contact or pivoted towards each other to release the frictional contact.

### BRIEF DESCRIPTION OF THE DRAWINGS

The present disclosure is explained below on the basis of exemplary embodiments with reference to the drawings. The drawings are schematic representations, in which:

FIG. 1 shows a plan view of an axial bearing provided for a bearing arrangement according to the disclosure,

FIG. 2 shows a sectional view through the axial bearing of FIG. 1, which additionally has two axial discs,

FIG. 3 shows a sectional view similar to FIG. 2, wherein the axial bearing has two angled discs, and

FIG. 4 shows a schematic diagram of a linear actuating device according to the disclosure in the form of a braking device, including a bearing arrangement according to the disclosure having a rotation-translation converter.

### DETAILED DESCRIPTION

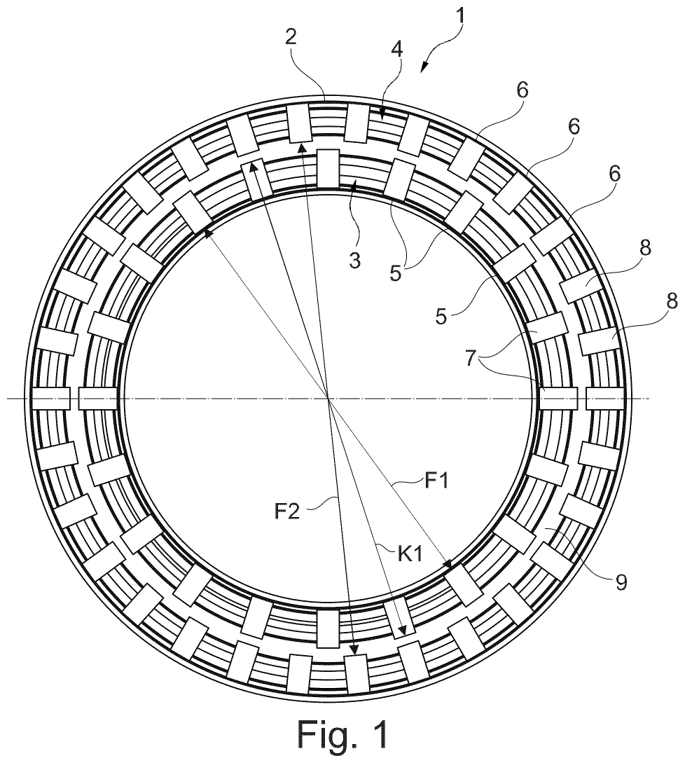

FIG. 1 shows an axial bearing 1 intended for integration into a bearing arrangement or linear actuating device according to the disclosure, including a cage 2 made, for example punched or lasered and formed, from a metal sheet, on which two separate pocket roller and cage assemblies are provided in two separate annular pocket zones 3, 4, in each of which rolling elements are accommodated. The radially inner first pocket zone 3 has a plurality of separate first pockets 5 which are equidistantly spaced from one another in the circumferential direction. The pockets 5 all lie on a common first root circle diameter F1. They all have the same length and width.

In the second pocket zone 4, which is located radially further outward, a plurality of second pockets 6 are also provided, spaced equidistantly from one another in the circumferential direction, all of which lie on a common second root circle diameter F2 and all of which also have the same length and the same width. In the embodiment according to FIG. 1, the first and second pockets 5, 6 all have the same length and the same width, so that they accommodate corresponding first rolling elements 7 in the first pockets and second rolling elements 8 in the second pockets, which rolling elements 7, 8 are each designed as elongated needles.

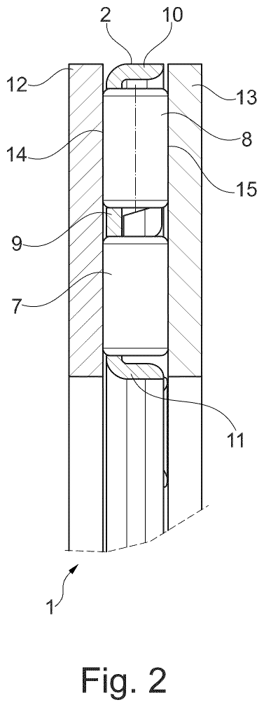

It can be seen that the second root circle diameter F2 is greater than the first root circle diameter F1. The second root circle diameter F2 is also slightly greater than the first crown circle diameter K1 of the first pockets 5, as shown in FIG. 1. This means that the second pockets 6 or the second pocket zone 4, when viewed radially, are radially spaced from each other via a narrow web 9, which is also shown in FIG. 2. Consequently, the pockets 5 are separated from the pockets 6 both in the radial direction and in the circumferential direction.

In the exemplary embodiment shown, the number of second pockets 6 is greater than the number of first pockets 5. In the circumferential direction, the distance between the second pockets 6 is therefore smaller than the distance between the first pockets 5. The second pockets 6 are partly located in radial extension of the first pockets or are in gaps between two adjacent first pockets 5.

As FIG. 2 shows, the cage 2 has a cylindrical rim 10 on the outer circumference and a likewise cylindrical rim 11 on the inner circumference, via which the cage is provided with the necessary stability. FIG. 2 also shows the rolling elements 7, 8, which are accommodated in the first and second pockets 5, 6.

Two axial discs 12, 13 designed as simple discs, each having running surfaces 14, 15 on which the rolling elements 7, 8 roll, are also shown. In the installation situation, the axial discs 12, 13 each rest on one of the components of the bearing arrangement which are to be supported against each other.

The axial bearing 1 has a number of advantages. On the one hand, the load-bearing capacity of the axial bearing can be varied to a large extent by dimensioning the number of pockets 5, 6 in the respective pocket zones 3, 4 according to the requirements. Thus, in addition to the design shown in FIG. 1, in which more second pockets 6 are provided than first pockets 5, it is conceivable to keep the number of pockets the same, in which case the second pockets 6 would all either be arranged in radial extension of a first pocket 5, or would all be located in gaps therebetween. The fewer the number of pockets, the lower the load-bearing capacity. As the number of pockets increases, the load-bearing capacity increases due to the higher number of rolling elements.

Another advantage is the compactness, as a one-piece ring 2 is used. This makes it possible to arrange the two pocket zones 3, 4, when viewed radially, very close to each other, and thus also to the rolling elements 7, 8. This is because the web 9 can be made very narrow so that the pocket zones 3, 4 and thus the pockets 5, 6 can be positioned as close to each other as possible. This means that the cage 2 is relatively narrow in radial terms and yet has a load-bearing capacity that would be achieved by a significantly wider, two-part cage of a double-row axial bearing. On the other hand, if the cage width is increased, the load-bearing capacity can also be significantly increased compared to a two-piece cage, since the pockets are radially longer and consequently longer rolling elements can be used.

The cage 2 itself is also very stable in terms of the pocket geometry, which is largely maintained even under load due to the cage reinforcement. Because the web 9 is formed between the two separate pocket zones 3, 4 which lie radially one inside the other, the pockets 5, 6 are shorter, when viewed radially, than in a comparable single-row bearing, which has a positive effect on the pocket geometry and the rolling element guidance. Of course, such an axial bearing or such a one-piece, but nevertheless two-row, cage is much easier to handle and assemble, as only one component has to be mounted, unlike a two-part cage, where the individual cage parts either have to be mounted separately or, in order to prevent them from falling apart, have to be fixed together.

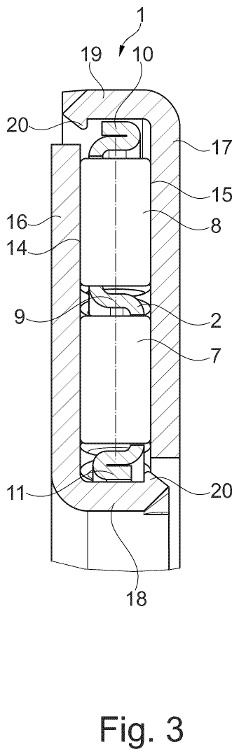

While FIG. 2 shows an exemplary embodiment of an axial bearing 1, in which two simple, flat axial discs 12, 13 are used, FIG. 3 shows an exemplary embodiment of an axial bearing 1 in which two angled discs 16, 17 are used as axial discs. Each angled disc has a cylindrical disc flange 18, 19, in the case of the angled disc 16 on the inner circumference, in the case of the angled disc 17 on the outer circumference. Each disc flange 18, 19 is provided with several latching lugs 20, which snap into place behind the double-layered annular rim 10, 11 of the cage 2, so that a fixed structural unit is formed, consisting of the cage 2 and the rolling elements 7, 8 in the corresponding pockets 5, 6 and the two angled discs 16, 17. The angled discs 16, 17 in turn provide the corresponding raceways 14, 15 on which the rolling elements 7, 8 roll. This axial bearing 1 is easier to handle and assemble than the axial bearing 1 from FIG. 2, in which the axial discs 12, 13 have to be installed separately because they are not connected to the cage 2, while the axial bearing 1 from FIG. 3 is a self-retaining structural unit. Although not shown, axial bearing designs are also conceivable which have only one self-retaining axial disc and are mounted on the other side directly on one of the components to be supported. This allows the required axial and radial installation space to be reduced.

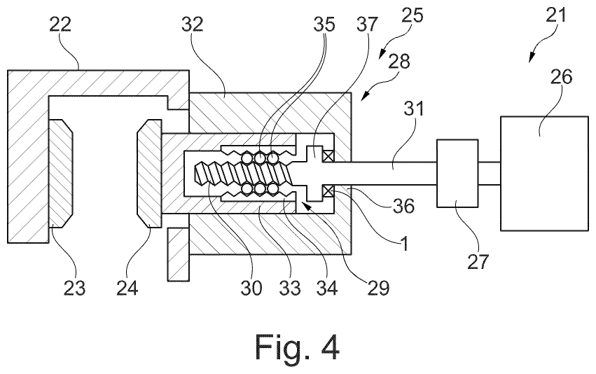

FIG. 4 finally shows a schematic diagram of a linear actuating device in the form of a braking device 21 comprising a bearing arrangement. The braking device 21, designed as a caliper brake, has a brake caliper 22 and two brake pads 23, 24, between which a brake disc (not shown in detail) is arranged. Furthermore, an actuator 25 is provided, via which the brake pad 24 can be moved axially and pressed against the brake disc. This means that a corresponding axial force can be applied to the brake pad 24 via the actuator 25.

The actuator 25 has an electric motor 26 with a downstream transmission 27. The transmission 27 is in turn connected to the integrated bearing arrangement or its rotation-translation converter 28, via which the rotational movement of the electric motor 26 or the output of the transmission 27 is converted into a translational movement for the linear displacement of the brake pad 24. For this purpose, the rotation-translation converter 28 is designed as a threaded spindle drive 29, comprising a threaded spindle 30 having an external thread, which is coupled with its spindle shaft 31 to the transmission 27. Furthermore, a threaded nut 34 is provided which is linearly movable, but rotationally secured, in a fixed housing 32 in which the rotation-translation converter 28 is accommodated and has an internal thread, which accommodates the threaded spindle 30 and which is connected to a piston 33. The threaded spindle 30 and the threaded nut 34 are coupled to each other via rolling elements 35 in the form of balls, as is usual in a threaded spindle drive. A rotation of the, when viewed axially, position-fixed threaded spindle 30 therefore inevitably leads to a linear displacement of the threaded nut 34 and the brake piston 33, which in turn is connected to the brake pad 24. Designs are also possible in which the brake piston and threaded nut are one component, or in which the linearly moving component (here the threaded nut) presses directly against the brake pad.

For axial support and rotary mounting of the threaded spindle 30, an axial bearing 1 is provided, which is arranged between the threaded spindle 30 or a collar 37 of the threaded spindle 30 and a flange 36 of the housing 32. The axial forces acting on the spindle drive 29 when the brake pad 24 is pressed are supported towards the housing 32 via the axial bearing 1 with its correspondingly high load-bearing capacity but low friction, while at the same time the threaded spindle 30 is pivotally mounted relative to the housing 32.

The bearing arrangement is formed in the example by the rotation-translation converter 28, the axial bearing 1 and the housing 32. The threaded spindle represents the first axially positionally fixed component which rotates as it is driven by the actuator, the threaded nut represents the linearly moving second component and the housing represents the axially positionally fixed support component. The first and the support components are supported or pivoted relative to each other via the axial bearing 1.

### REFERENCE NUMERALS

1 Axial bearing
2 Cage
3 Pocket zone
4 Pocket zone
5 Pocket
6 Pocket
7 Rolling element
8 Rolling element
9 Web
10 Annular rim
11 Annular rim
12 Axial disc
13 Axial disc
14 Running surface
15 Running surface
16 Angled disc
17 Angled disc
18 Disc flange
19 Disc flange
20 Latching lug
21 Braking device
22 Brake caliper
23 Brake pad
24 Brake pad
25 Actuator
26 Electric motor
27 Transmission
28 Rotation-translation converter
29 Threaded spindle drive
30 Threaded spindle
31 Spindle shaft
32 Housing
33 Piston
34 Threaded nut
35 Rolling element
36 Flange
37 Collar
F1 Root circle diameter
F2 Root circle diameter
K1 Crown circle diameter

1. A bearing arrangement, comprising a rotation-translation converter that comprises an axially positionally fixed, rotating first component and a second component that is axially movable by rotation of the first component; a support component; and
an axial bearing via which the rotating first component is supported on the support component, wherein the axial bearing is a needle bearing that has only one cage, wherein the cage has a plurality of first pockets which are populated with needles and have a first root circle diameter (F1), and a plurality of second pockets which are separate from the first pockets, are populated with needles and have a second root circle diameter (F2), wherein the second root circle diameter (F2) is greater than the first root circle diameter (F1).

2. The bearing arrangement according to claim 1, wherein the second root circle diameter (F2) is greater than a first crown circle diameter (K1) of the first pockets, or that the second root circle diameter (F2) is smaller than the first crown circle diameter (K1).

3. The bearing arrangement according to claim 1, wherein the number of first pockets corresponds to the number of second pockets, or that the number of first pockets is smaller than the number of second pockets, or vice versa.

4. The bearing arrangement according to claim 1, wherein the first and the second pockets, seen in the radial direction, have the same length, or that the first and the second pockets seen in the radial direction, have different lengths.

5. The bearing arrangement according to claim 1, wherein a cylindrical annular rim is provided on the inner circumference and/or on the outer circumference of the cage.

6. The bearing arrangement according to claim 1, further comprising one or two axial discs, on which the rolling elements roll.

7. The bearing arrangement according to claim 6, wherein the or each axial disc is designed as an angled disc, which has a cylindrical disc flange which is snapped onto an annular rim of the cage.

8. A linear actuating device, comprising an actuating element to be moved linearly, an electromotive actuator, and a bearing arrangement according to claim 1, wherein the actuator is coupled to the first component of the rotation-translation converter, while the second component of the rotation-translation converter is coupled to the actuating element to be moved.

9. The linear actuating device according to claim 8, wherein the linear actuating device is a braking device comprising at least two brake pads at least one of which is the actuating element to be moved and is to be moved by means of the actuator against a braking element to be decelerated.

10. The linear actuating device according to claim 9, wherein the linear actuating device is a caliper brake or a drum brake.

11. A bearing arrangement, comprising:
a rotation-translation converter, comprising:
a first component that is axially positionally fixed and rotatable;
a second component that is axially movable by rotation of the first component;
a support component; and
an axial bearing for supporting the first component on the support component, the axial needle bearing comprising a single cage, the single cage comprising
a plurality of first pockets populated by first needles and comprising a first root circle diameter; and
a plurality of second pockets, separate from the first pockets, populated by second needles and comprising a second root circle diameter that is greater than the first root circle diameter.

12. The bearing arrangement of claim 11, wherein:
the first pockets comprise a first crown circle diameter; and
the second root circle diameter is different than the first crown circle diameter

13. The bearing arrangement of claim 11, wherein the single cage comprises a cylindrical annular rim arranged on an inner circumference or an outer circumference.

14. The bearing arrangement of claim 11, further comprising an axial disc, wherein the first needles and the second needles are arranged to roll on the axial disc.

15. The bearing arrangement of claim 14, wherein:
the cage comprises an annular rim; and
the axial disc is an angled disc comprising a cylindrical disc flange snapped onto the annular rim.
